(19) United States
(12) Patent Application Publication
(10) Pub. No.: US 2020/0124127 A1
(43) Pub. Date: Apr. 23, 2020

(54) FRICTION MATERIAL

(71) Applicant: ADVICS CO., LTD., Kariya-shi, Aichi-ken (JP)

(72) Inventor: Manabu MURAKAMI, Nagoya-shi, Aichi-ken (JP)

(73) Assignee: ADVICS CO., LTD., Kariya-shi, Aichi-ken (JP)

(21) Appl. No.: 16/606,005

(22) PCT Filed: May 24, 2018
(86) PCT No.: PCT/JP2018/019921

§ 371 Date: Oct. 17, 2019

(30) Foreign Application Priority Data
May 24, 2017 (JP) 2017-102809

(51) Int. Cl. F16D 69/02

(52) U.S. Cl. CPC F16D 69/026; F16D 2200/0056; F16D 2200/0065

(57) ABSTRACT

Provided is a friction material that comprises a fiber base material, a bonding material, an organic filler, and an inorganic filler, wherein: the contained amount of a copper element is at most 0.5 wt % with respect to the total amount of friction material; the inorganic filler contains an inorganic matter having a Mohs hardness of at least 6.5 and a cleavable inorganic matter; the contained amount of the inorganic matter having a Mohs hardness of at least 6.5 is less than 1.0 wt % with respect to the total amount of the friction material; and the contained amount of the cleavable inorganic matter is 12.0-24.0 wt % with respect to the total amount of the friction material.

### TECHNICAL FIELD

The present invention relates to a friction material used for a brake device or the like for vehicles.

### BACKGROUND ART

The friction material used for brake pads, brake shoes of vehicles and the like is required to have various characteristics such as high effect (high coefficient of friction), long lifespan (wear resistance) and the like.

Conventionally, a copper component having high thermal conductivity and excellent ductility is contained in the friction material for the purpose of maintaining the coefficient of friction and imparting wear resistance. However, nowadays, environmental concerns are increasing on a global scale, and development of friction materials (copper-free) with reduced copper components of high environmental load is urgently needed. However, due to the reduction of the copper component, various problems such as the deterioration of the wear resistance and the occurrence of a metal pick up (MPU, synonymous with metal catch) have become apparent. Metal pick-up is a phenomenon in which wear powder generated when the friction material slides against the mating material, such as the rotor, adheres to the sliding surface of the friction material to form a metal block, and the metal block is pushed into the sliding surface of the friction material and fixed by the pressure at the time of sliding. As a result, problems arise such as the metal block inside the friction material significantly grinding the mating material, and the friction material being abnormally worn by the ground mating material.

Thus, attempts have been made to construct a friction material that can reduce the occurrence of metal pick-up without causing deterioration in high temperature wear resistance due to the reduction of the copper component.

For example, Patent Literature 1 reports a non-asbestos-based friction material for achieving both wear resistance at high temperature, which lowers due to reduction of copper components, and suppression of metal pick-up. Specifically, the non-asbestos-based friction material of Patent Literature 1 has a flaky, columnar or plate-like shape and contains 10 to 35% by mass of titanate, which specific surface area is 0.5 to 10 m²/g. At the same time, it contains 5 to 30% by mass of zirconium oxide, and the contained amount of zirconium oxide having a particle diameter exceeding 30 μm is adjusted to at most 1.0% by mass.

Furthermore, Patent Literature 2 discloses a friction material containing 1.0 to 25.0 wt % of mica which is a cleavable inorganic matter, but contains 2 wt % of aluminum oxide (alumina) having a Mohs hardness of 9.0. In a case where 10.0 wt % of copper fiber is contained as in Patent Literature 2, even if a relatively large amount of highly aggressive abrasive raw material such as aluminum oxide is contained, the wear of the mating material can be suppressed since an adhesive coating is formed on the surface of the mating material by the ductility of the copper component.

### CITATIONS LIST

### Patent Literatures

Patent Literature 1: Japanese Unexamined Patent Application Publication No. 2012-255052
Patent Literature 2: Japanese Unexamined Patent Application Publication No. 3-239784

### SUMMARY OF INVENTION

### Technical Problems

The non-asbestos-based friction material of Patent Literature 1 contains 10 to 35% by mass of titanate and contains 5 to 30% by mass of zirconium oxide having a specific particle diameter to compensate for the wear resistance at high temperature which lowers due to reduction of copper components and the occurrence of metal pick-up. However, since the contained amount of zirconium oxide is as large as 5 to 30% by mass, the attacking property to the mating material such as the rotor, or the like tends to become too high. Therefore, there is a problem in that wear of the mating material and deterioration of judder (brake vibration) due to DTV (disk thickness variation, disk thickness difference) growth are easily assumed. That is, since zirconium oxide, which is an abrasive raw material (grinding material), obtains a braking force by scraping the mating material at the time of braking, the wear of the mating material is extremely deteriorated when the contained amount of the abrasive raw material increases. Furthermore, even at the time of idling (time of traveling on an expressway, etc.), the wear quantity of the mating material increases due to the drag (contact) of the brake pad, which causes the DTV to grow and causes judder generation at the time of braking.

In addition, it can be easily understood that when the friction material of Patent Literature 2 is configured as a copper-free friction material substantially free of copper components, the attacking property of the abrasive raw material promotes the wear of the mating material, which causes decrease in the lifespan of the mating material. Therefore, in the copper-free friction material, it is important to adjust not only the cleavable inorganic matter but also the contained amount (wt %) of the inorganic matter having a Mohs hardness of at least 6.5.

The present invention aims to provide a friction material that exhibits excellent wear resistance while securing sufficient braking force and stability of effect at the time of braking, and that has an excellent performance in that its attacking property to the mating material is small and that it can suppress the occurrence of metal pick-up and DTV growth.

### Solutions to Problems

The inventors of the present invention have intensively conducted a study to solve the above problems, and constructed a non-asbestos-based friction material that, as an inorganic filler, limits the contained amount of an inorganic matter having a Mohs hardness of at least 6.5 to less than a predetermined wt % with respect to the total amount of friction material, and contains a cleavable inorganic matter within the range of a predetermined wt % in the friction material. According to the non-asbestos-based friction material, it has been found that the attacking property to the mating material such as a rotor can be reduced, and the occurrence of metal pick-up and DTV growth can be suppressed. Furthermore, it has also been found that it has excellent wear resistance while securing sufficient braking force and stability of effect at the time of braking.

That is, the present invention provides a friction material having the following configuration.

A friction material is provided that includes a fiber base material, a binder, an organic filler, and an inorganic filler. In the friction material, a contained amount of copper element is at most 0.5 wt % with respect to a total amount of the friction material, an inorganic matter having a Mohs hardness of at least 6.5 and a cleavable inorganic matter are contained as the inorganic filler, the contained amount of the inorganic matter having a Mohs hardness of at least 6.5 is less than 1.0 wt % with respect to the total amount of the friction material, and the contained amount of the cleavable inorganic matter is at least 12.0 wt % and at most 24.0 wt % with respect to the total amount of the friction material.

According to the above configuration, a friction material is provided that exhibits excellent wear resistance while securing sufficient braking force and stability of effect at the time of braking, and that has an excellent performance in that the attacking property to the mating material such as a rotor is small and the occurrence of metal pick-up and DTV growth can be suppressed. The friction material having the present configuration is also applied to the trend of copper free. Specifically, the wear of the mating material can be effectively suppressed, and the occurrence of metal pick-up and DTV growth due to the wear of the mating material can be effectively suppressed by reducing the contained amount of the abrasive raw material harder than the mating material as much as possible. On the other hand, it has been conventionally known that when the contained amount of the abrasive raw material is small, insufficient effect at the time of braking occurs. When the cleavable inorganic matter is contained, the sliding surfaces of the friction material and the mating material can be maintained in a clean state by the cleaning effect of the cleavable inorganic matter. Thus, sufficient braking force can be secured and the stability of effect can be enhanced even by suppressing the contained amount of the abrasive raw material to a very small amount.

### BRIEF DESCRIPTION OF DRAWINGS

FIG. 1 is a view summarizing a composition of a friction material raw material and the performance evaluation thereof according to examples of a friction material in accordance with the present embodiment.

FIG. 2 is a view summarizing a composition of a friction material raw material and the performance evaluation thereof according to examples and comparative examples of a friction material in accordance with the present embodiment.

### DESCRIPTION OF EMBODIMENT

Hereinafter, although an embodiment of the present invention is described in detail, the present invention is not limited by the following embodiment to an extent not exceeding its purpose.

The friction material according to the present embodiment contains a fiber base material, a binder, an organic filler, an inorganic filler, and the like to be described later, and contains, as the inorganic filler, cleavable inorganic matter within a range of a predetermined wt % while limiting the contained amount of an inorganic matter having a Mohs hardness of at least 6.5 to less than a predetermined wt % with respect to the total amount of friction material. Preferably, iron oxide is contained as an inorganic filler.

In addition to these, materials generally used in producing the friction material can also be contained. Here, all the materials mixed in producing the friction material according to the present embodiment are referred to as a friction material raw material.

The friction material according to the present embodiment is a non-asbestos-based friction material (NAO material). Furthermore, the friction material according to the present embodiment does not substantially contain a copper component having a high environmental load (copper free). Specifically, the copper component is not contained, or even when contained, it is at most 0.5 wt % with respect to the total amount of friction material raw material.

However, nowadays, environmental concerns are increasing on a global scale, and development of friction materials with reduced copper components of high environmental load is urgently needed. However, due to the reduction of the copper component, for example, various problems such as deterioration of the wear resistance and occurrence of metal pick-up and DTV growth have become apparent. The friction material of the present embodiment is one in which the contained amount of the abrasive raw material that is harder than the mating material, such as the rotor, and has strong attacking property is reduced as much as possible. Thus, the wear of the mating material can be effectively suppressed, and the occurrence of metal pick-up and DTV growth resulting from the wear of the mating material can be effectively suppressed. Furthermore, the insufficient effect at the time of braking by the reduction of the abrasive raw material can be effectively resolved by the cleavable inorganic matter. Thus, excellent wear resistance can be demonstrated while securing sufficient braking force and stability of effect at the time of braking, the attacking property to the mating material is small, and the occurrence of metal pick-up and DTV growth can be suppressed. Therefore, the friction material according to the present embodiment sufficiently responds to the movement of copper free.

The fiber base material can be exemplified by organic fibers, metal fibers, natural or synthetic inorganic fibers, and the like. Specific examples of the fiber base material include, as organic fibers, aromatic polyamide fibers (aramid fibers), acrylic fibers, cellulose fibers, carbon fibers, and the like. Examples of metal fiber include pure metals such as steel, stainless steel, aluminum, zinc, and tin, and fibers made of respective alloy metals. Examples of inorganic fiber include rock wool, glass fiber and the like. One type of fiber base material may be used alone or a plurality of types may be used in combination. Furthermore, the contained amount of the fiber base material is not particularly limited, but it can be contained preferably in an amount of 3.0 wt % to 15.0 wt % with respect to the total amount of friction material raw material.

The binder has a function of binding the friction material raw materials. As specific examples of the binder, phenolic resin, epoxy resin, melamine resin, imide resin, and the like, and modified resins thereof such as elastomer, hydrocarbon resin, and epoxy can also be used. One type of binder may be used alone or a plurality of types may be used in combination. Furthermore, the contained amount of the binder is not particularly limited, but it can be contained preferably in an amount of 3.0 to 10.0 wt % with respect to the total amount of friction material raw material.

The organic filler can contain cashew dust, rubber powder, tire powder, fluoropolymer and the like, which can be used alone or in combination of a plurality of types. However, the present invention is not limited to the specific examples described above, and organic fillers known in the technical art can be preferably used. The contained amount of the organic filler is also not particularly limited, and may be a contained amount generally used in the technical art.

As the inorganic filler, a cleavable inorganic matter within a range of a predetermined wt % is contained while limiting the contained amount of the inorganic matter having a Mohs hardness of at least 6.5 to less than a predetermined wt % with respect to the total amount of friction material raw material. Preferably, iron oxide is contained as an inorganic filler.

The contained amount of the inorganic matter having a Mohs hardness of at least 6.5 is adjusted to be at least 0.1 wt % and less than 1.0 wt %, preferably at least 0.2 wt % and less than 1.0 wt % with respect to the total amount of friction material raw material. The inorganic matter having a Mohs hardness of at least 6.5 is mainly contained in the friction material as a grinding material (abrasive) material for providing grinding characteristics. The friction material of the present embodiment is one in which the contained amount of the abrasive raw material that is harder than the mating material such as the rotor is reduced as much as possible. Thus, the wear of the mating material can be effectively suppressed, and the occurrence of metal pick-up and DTV growth resulting from the wear of the mating material can be effectively suppressed. Therefore, when it becomes at least 1.0 wt %, the attacking property of the mating material becomes high, which is not preferable.

As the inorganic matter having a Mohs hardness of at least 6.5, for example, zirconium silicate, zirconium oxide (zirconia), silica such as silicon dioxide, ceramic powder, aluminum oxide (alumina), chromium oxide (chromium oxide (II) etc.), and the like. However, without being limited thereto, the inorganic matters having a Mohs hardness of at least 6.5 known in the technical art can be preferably used.

The shape of the inorganic matter having a Mohs hardness of at least 6.5 is not particularly limited as long as it can effectively exhibit the above-mentioned characteristics and it is mixed with other friction material raw materials uniformly, but it is preferable to set the average particle diameter to at most 25 μm. The attacking property on the mating material such as a rotor can be prevented from becoming higher than necessary, and the wear of the mating material can be effectively suppressed by setting the average particle diameter to at most 25 μm. The shape of the inorganic matter having a Mohs hardness of at least 6.5 is not particularly limited as long as it can effectively exhibit the above-mentioned characteristics and it is mixed with other friction material raw materials uniformly, and that of a known form used in the technical art can be used. For example, it can be in the form of powder, particle, fibers, and the like.

The cleavable inorganic matters are mainly contained to impart excellent cleaning characteristics to the friction material. The sliding surfaces of the friction material and the mating material, such as the rotor, can be effectively updated, that is, the cleaning characteristics can be improved, and the sliding surfaces of the friction material and the mating material can always be maintained in a clean state by containing the cleavable inorganic matter in the friction material. Generally, it is known that an insufficient effect at the time of braking occurs when the contained amount of the abrasive raw material is small. However, sufficient braking force can be secured and stability of effect can be enhanced even by suppressing the contained amount of the abrasive raw material to a very small amount by maintaining the sliding surfaces of the friction material and the mating material in a clean state.

Here, the cleavable inorganic matter is an inorganic matter having a property of peeling in the direction of weak bonding force between atoms in the crystal structure. The form of cleavage is not particularly limited as long as the cleavable inorganic matter has the above-mentioned characteristics, and examples thereof include those having cleavage in plate shape, columnar shape, hexahedron, octahedron, and the like. Furthermore, the smoothness of the cleavage plane is also not particularly limited, and for example, even if it cleaves to a nearly perfect plane or cleaves to a slightly perfect plane, it may be that which has unevenness but planarity is clearly recognized or that which planarity is barely recognized. Furthermore, the direction of cleavage is also not particularly limited, and examples thereof include those in 1, 2, 3, 4 and 6 directions.

Specific examples of the cleavable inorganic matter include mica, calcite, galena, molybdenite, talc, kaolinite, fluorite, amphibole, feldspar, kyanite, olivine, aragonite, and the like as long as it has the above characteristics, but these are not the sole case. Particularly preferable one is mica, where mica groups include muscovite, phlogopite, annite, biotite and the like, and any may be used. One type of cleavable inorganic matter may be used alone or a plurality of types may be used in combination.

The shape and size of the cleavable inorganic matter are not particularly limited as long as they can effectively exhibit the above-mentioned characteristics and it is mixed with other friction material raw materials uniformly, and that of a known form and dimension used in the technical art can be used. For example, it can be in the form of powder, particle, fibers, and the like.

The contained amount of the cleavable inorganic matter is at least 12.0 wt % and at most 24.0 wt % with respect to the total amount of friction material raw material. When the contained amount of the cleavable inorganic matter exceeds 24.0 wt %, the strength of the friction material lowers and the wear resistance tends to deteriorate, which is not preferable. On the other hand, when the contained amount is less than 12.0 wt %, the above-mentioned cleaning characteristics cannot be effectively exhibited, and hence the contained amount is preferably within the range of the above-mentioned wt %.

Iron oxide is mainly contained to provide weak grinding characteristics to the friction material. The insufficient effect at the time of braking due to reduction in the contained amount of the abrasive raw material represented by the inorganic matter having a Mohs hardness of at least 6.5 can be resolved by containing the iron oxide in addition to the cleavable inorganic matter. Furthermore, in combination with the excellent cleaning characteristics of the cleavable inorganic matter, it is possible to secure a sufficient braking force and enhance the stability of effect.

Iron oxide is an inorganic matter having a Mohs hardness of 6.0, and any of ferric oxide (Fe₂O₃) and triiron tetraoxide (Fe₃O₄) can be used.

The attributes and size of the iron oxide are not particularly limited as long as they can effectively exhibit the above-mentioned characteristics and it is mixed with other friction material raw materials uniformly, and that of a known form and dimension used in the technical art can be used. For example, it can be in the form of powder, particle, fibers, and the like.

The contained amount when the iron oxide is contained is preferably at least 5.0 wt % and at most 15.0 wt % with respect to the total amount of friction material raw material. Sufficient braking force can be secured and stability of effect can be effectively enhanced by adjusting to within the range of such wt %.

2018 As the inorganic filler, other than the inorganic matter having a Mohs hardness of at least 6.5 of less than a constant wt %, the cleavable inorganic matter within a range of a predetermined wt %, and the iron oxide, various compounds can be contained as needed.

For example, titanates can be contained. Examples of titanates includes titanic acid alkali metal salt and titanic acid alkali metal/group II salt, and specific examples thereof include potassium titanate, sodium titanate, lithium titanate, lithium potassium titanate, and magnesium potassium titanate. The titanate is preferably contained in an amount of 10.0 wt % to 30.0 wt % with respect to the total amount of friction material raw material. This can compensate for the deterioration of the wear resistance due to the reduction of the copper component.

Furthermore, calcium hydroxide and the like can be contained as a pH modifier.

In addition, pure metals such as iron (steel), aluminum, zinc and tin, and metals other than copper such as metal powder and metal fiber of respective alloy metals can be contained as needed, and the strength of the friction material can be enhanced. However, metal such as metal powder and metal fiber is not an essential component of the friction material and does not necessarily need to be contained from the viewpoint of cost reduction and the like.

An inorganic friction adjusting material for adjusting the friction characteristics of the friction material may be further contained, but the content of the abrasive raw material represented by the inorganic matters having a Mohs hardness of at least 6.5 is limited as described above.

These inorganic fillers may be used alone or in combination of a plurality of types. The contained amount of the inorganic filler is also not particularly limited, and may be a contained amount generally used in the technical art.

Furthermore, a lubricant material can be contained in the friction material of the present embodiment, and specific examples thereof include coke, black lead (graphite), carbon black, metal sulfide, and the like. Examples of metal sulfides include tin sulfide, antimony trisulfide, molybdenum disulfide, tungsten sulfide. The lubricant material may be used alone or in combination of a plurality of types. The contained amount of the lubricant material is also not particularly limited, and may be a contained amount generally used in the technical art.

The friction material of the present embodiment can be manufactured through a method known in the technical art, and can be manufactured by a mixing process of blending and mixing the friction material raw material and a molding process of molding the mixed friction material raw material to a desired shape.

Here, in the mixing process, the friction material raw material is preferably mixed in powder form, so that the friction material raw material can be uniformly mixed easily. The mixing method is not particularly limited as long as the friction material raw material can be uniformly mixed, and the mixing can be carried out through methods known in the technical art. Preferably, mixing can be performed using a mixer such as a Henschel mixer or a Loedige mixer, and for example, mixing is performed for about 10 minutes at normal temperature. At this time, the friction material raw material may be mixed while being cooled through a known cooling method so that the temperature of the mixture of the friction material raw material does not rise.

The molding process can be performed by pressing and solidifying the friction material raw material with a press or the like, and can be performed based on methods known in the technical art. When performing molding with a press, the molding may be performed through either a hot press method in which the friction material raw material is molded by being heated, pressed and solidified, or a normal temperature press method in which the friction material raw material is molded by being pressed and solidified at normal temperature without being heated. In the case where the molding is performed by the hot press method, for example, the molding temperature is 140° C. to 200° C. (preferably 160° C.), the molding pressure is 10 MPa to 30 MPa (preferably 20 MPa), and the molding time is 3 minutes to 15 minutes (preferably 10 minutes). In the case where the molding is performed by the normal temperature press method, for example, molding can be performed by setting the molding pressure to 50 MPa to 200 MPa (preferably 100 MPa) and the molding time to 5 seconds to 60 seconds (preferably 15 seconds). Subsequently, clamp processing (e.g., 180° C., 1 MPa, 10 minutes) is performed. Thereafter, heat treatment (preferably 230° C., 3 hours) can be performed at 150° C. to 250° C. for 5 minutes to 180 minutes.

Furthermore, a polishing process may be provided to polish the surface of the friction material to form a friction surface, if necessary.

The friction material according to the present embodiment can be applied to a disc brake pad of a vehicle or the like, but is not limited thereto, and can be applied to any object to which a friction material known in the technical art such as a brake shoe can be applied. For example, the friction material according to the present embodiment can be integrated with a plate-like member such as a metal plate serving as a back plate and used as a brake pad.

According to the friction material of the present embodiment, a friction material that exhibits excellent wear resistance while securing sufficient braking force and stability of effect at the time of braking, and that has an excellent performance of reducing the attacking property on the mating material such as the rotor and suppressing the occurrence of metal pick-up and DTV growth can be provided. The friction material of the present embodiment is also adapted to the copper free flow. Specifically, the wear of the mating material can be effectively suppressed, and the occurrence of metal pick-up and DTV growth due to the wear of the mating material can be effectively suppressed by reducing the contained amount of the abrasive raw material harder than the mating material as much as possible. On the other hand, it has been conventionally known that when the contained amount of the abrasive raw material is small, insufficient effect at the time of braking occurs. When the cleavable inorganic matter is contained, the sliding surfaces of the friction material and the mating material can be maintained in a clean state by the cleaning effect of the cleavable inorganic matter. Thus, sufficient braking force can be secured and the stability of effect can be enhanced even by suppressing the contained amount of the abrasive raw material to a very small amount.

Furthermore, the insufficient effect at the time of braking due to the reduction in the contained amount of the abrasive raw material can be resolved by containing iron oxide in the friction material of the present embodiment in addition to the inorganic matter having a Mohs hardness of at least 6.5 of less than a predetermined wt % and the cleavable inorganic matter within a range of a predetermined wt %. In combination with the excellent cleaning characteristics of the cleavable inorganic matter, it is possible to secure sufficient braking force and enhance stability of effect.

### EXAMPLES

Examples of the friction material according to the present embodiment will be described below, but the present invention is not to be limited to these examples.

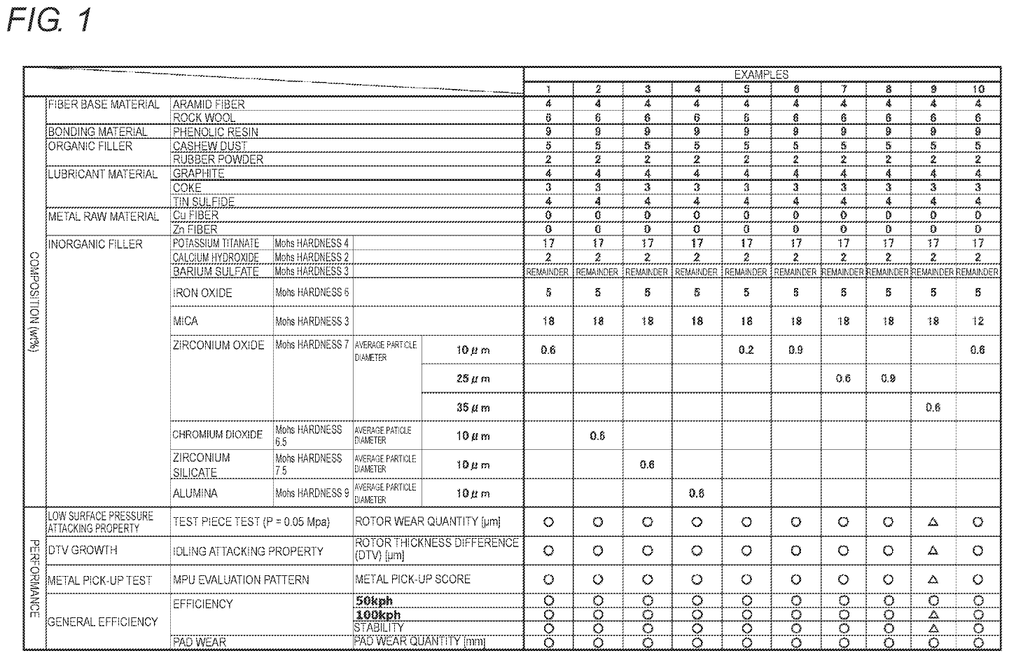

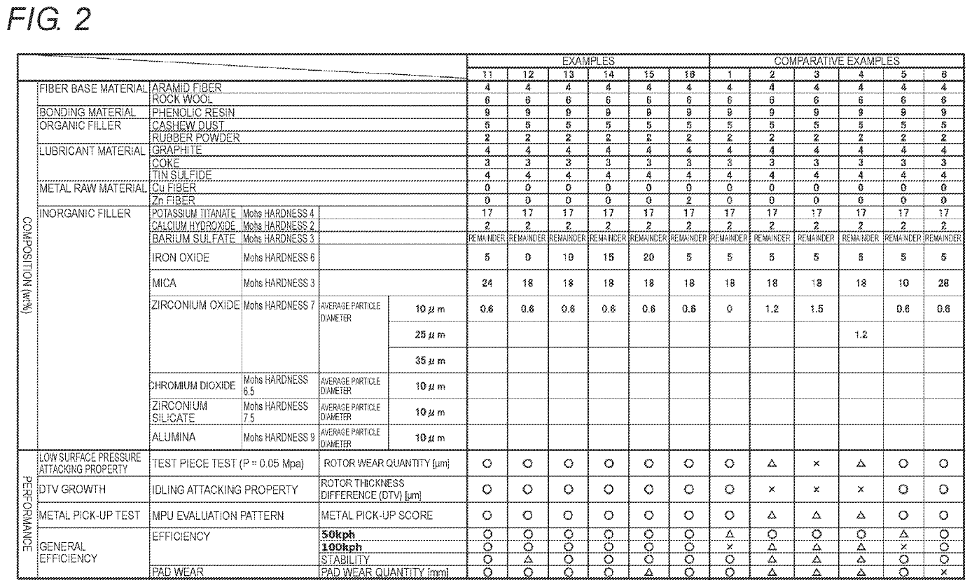

In the first to sixteenth examples and first to sixth comparative examples, a friction material prepared by blending a friction material raw material according to the compounding amount shown in FIGS. 1 and 2 was used for a brake pad, and evaluation on low surface pressure attacking property, DTV growth, metal pick-up occurrence, and general efficiency was made. The unit of blending amount in the composition of each friction material raw material in the figure is wt % with respect to the total amount of friction material raw material.

A. Low Surface Pressure Attacking Property Test (Test Piece Test: P=0.05 MPa)

(Sample) A 25 mm×25 mm test piece was used as a friction material.

A rotor of material FC200 was used as the rotor.

(Test Conditions)

The wear quantity (μm) of the rotor when the test piece was idled at V=100 km/h for 24 hours while being pressed against the rotor at low surface pressure (0.05 MPa) was measured. The rotor thickness difference before and after the low surface pressure attacking property test was taken as the wear quantity (μm).

### (Evaluation)

Here, the wear quantity was evaluated in three stages according to the following criteria.

∘: less than 10 μm

Δ: at least 10 μm, less than 20 μm

x: at least 20 μm

### B. DTV Growth Test (Idling Attacking Property Test)

### (Sample)

The brake assembly for the passenger vehicle (caliper, pad (friction material), rotor) was used.

### (Test Conditions)

The rotor thickness difference (DTV) at each friction surface along the entire circumference (12 points in the circumferential direction) when the following test was conducted was measured using the dynamometer for brake evaluation.

1. Braking: One brake was applied at a velocity of 100 km/h and a hydraulic pressure of 6 MPa.

2. Idle: The vehicle was idled for 30 minutes at a velocity of 100 km/h.

A total of 30 cycles were performed with the above 1 and 2 as one cycle, and the rotor thickness difference at the end of the DTV growth test was taken as the DTV (μm).

### (Evaluation)

Here, the DTV was evaluated three stages according to the following criteria.

∘: less than 5 μm

Δ: at least 5 μm, less than 10 μm

x: at least 10 μm

### C. Metal Pick-Up Test

### (Sample)

The brake assembly for the passenger vehicle (caliper, pad (friction material), rotor) was used.

### (Test Conditions)

The metal pick-up state of the friction material and rotor when the following test was conducted was confirmed using the dynamometer for brake evaluation.

1. Temperature rising braking: The temperature was raised to a temperature of 200° C. at a speed of 60 km/h and a hydraulic pressure of 2 MPa.

2. MPU braking: 30 brakes were applied at a speed of 80 km/h, a hydraulic pressure of 1.5 MPa, and a temperature of 200 to 250° C.

3. Cooling: Cooled was performed to a temperature of 40° C. at a speed of 30 km/h.

A total of 30 cycles were performed with the above 1 to 3 as one cycle. The friction material and the rotor were observed at the end of the metal cap test, and the occurrence of metal pick-up in the friction material and the generation of scratches in the rotor were confirmed.

### (Evaluation)

The metal pick-up score was evaluated in three stages according to the following criteria.

∘: No occurrence

Δ: metal pick-up occurred on friction material surface

x: Scratches on rotor surface

### D. General Efficiency Test

The brake assembly for the passenger vehicle (caliper, pad (friction material), rotor) was used.

### (Test Conditions)

The efficiency and pad wear quantity were evaluated in accordance with JASO C406.

### (Evaluation/Efficiency (80° C.))

In the general efficiency test, the average coefficient of friction (μ) at a velocity of V=50 km/h (50 kph) or a velocity of V=100 km/h (100 kph) and deceleration of G=6.0 m/s² of the second efficiency test at 80° C. was measured. Here, the efficiency was evaluated in three stages according to the following criteria.

∘: Average coefficient of friction is at least 0.35μ, 0.45μ or less

Δ: Average coefficient of friction is at least 0.30μ, less than 0.35, or greater than 0.45μ, at most 0.50μ

x: Average coefficient of friction is less than 0.30μ or greater than 0.50 t

### (Evaluation—Stability of Efficiency)

In the general efficiency test, the proportion (%) of the absolute value of the difference between the average coefficient of friction (μ) at the deceleration G=3.0 m/s² and the average coefficient of friction (μ) at the deceleration 9.0 m/s² of each velocity of the second efficiency test at 80° C. and the average coefficient of friction (μ) at G=6.0 m/s² and the average coefficient of friction (μ) at G=6.0 m/s² was calculated as the efficiency difference. The stability of efficiency was evaluated in three stages according to the following criteria.

∘: Efficiency difference is within 15%

Δ: Efficiency difference is greater than 15%, within 25%

x: Efficiency difference is greater than 25%

### (Evaluation—Wear Resistance)

The thickness of the pad (friction material) before and after the general efficiency test was measured, and the difference in thickness was taken as the pad wear quantity (mm). Here, the wear resistance was evaluated in three stages according to the following criteria.

∘: less than 1.5 mm

Δ: at least 1.5 mm, less than 2.5 mm

x: at least 2.5 mm

The results are shown in FIGS. 1 and 2. In the first to sixteenth examples, good results were obtained in all of the rotor wear, DTV growth, occurrence of metal pick-up, efficiency, and pad wear. Thus, it was found that the friction material of the present example can suppress the wear of the rotor and effectively suppress the DTV growth and the occurrence of metal pick-up while securing satisfactory brake efficiency and wear resistance of the friction material.

In the ninth example in which the average particle diameter of zirconium oxide is 35 μm, it was found that the rotor wear, DTV growth, occurrence of metal pick-up, efficiency at high speed (100 kph), and stability of efficiency slightly reduced. Thus, in order to effectively suppress the rotor wear, it was found preferable to control the average particle diameter of the inorganic matters having a Mohs hardness of at least 6.5 such as a zirconium oxide. Furthermore, in the twelfth example in which iron oxide is not contained, it was found that the stability of efficiency slightly reduced. Moreover, in the fifteenth example in which 20 wt % of iron oxide is contained, it was found that the wear resistance slightly reduced. Thus, it was found preferable to contain iron oxide in an amount of at least 5 wt % and at most 15 wt % in order to ensure the stability of efficiency and ensure the wear resistance. Furthermore, in the sixteenth example in which zinc fiber is contained, it was found that containing metal such as zinc fiber or metal alloy fiber in the friction material is not particularly limited as good results were obtained in all of rotor wear, DTV growth, occurrence of metal pick-up, efficiency and pad wear. However, since good results were obtained even in the cases of first to fifteenth examples in which metal or metal alloy fiber is not contained, they may not be contained from the viewpoint of cost and the like.

On the other hand, in the first comparative example in which zirconium oxide is not contained, good results were not be obtained in terms of efficiency, and efficiency particularly at high speed (100 kph) deteriorated. In contrast to obtaining satisfactory efficiency in the fifth example in which zirconium oxide is contained although by a small amount of 0.2 wt %, it is preferable to include at least 0.2 wt % of the inorganic filler having a Mohs hardness of at least 6.5.

In the fourth comparative example in which 1.2 wt % of zirconium oxide having an average particle diameter of 25 m is contained, good results were not be obtained in the rotor wear, DTV growth, occurrence of metal pick-up, efficiency at high speed (100 kph), stability of efficiency, and pad wear. In particular, significant DTV growth was recognized, and there was a problem in terms of attacking property on the rotor. Furthermore, even in a case where the average particle diameter is reduced to 10 m, in the second and third comparative examples in which 1.2 wt % and 1.5 wt % of zirconium oxide is contained, good results were not be obtained in the rotor wear, DTV growth, occurrence of metal pick-up, efficiency at high speed, stability of efficiency, and pad wear. In particular, significant rotor wear and DTV growth were recognized, and there was a problem in terms of attacking property on the rotor. On the other hand, in the first to sixteenth examples in which good results were obtained, the contained amount of zirconium oxide is adjusted to at least 0.2 wt % and less than 1.0 wt %. According to such results, it is found necessary to adjust the contained amount of the inorganic matter having a high Mohs hardness such as zirconium oxide to a very small amount (less than 1.0 wt %) in order to effectively suppress the attacking property on the rotor.

Furthermore, in the fifth comparative example in which only 10.0 wt % of cleavable inorganic matter mica is contained, it was found that the efficiency, particularly the efficiency at high speed (100 kph) deteriorated. On the contrary, in the sixth comparative example in which 28.0 wt % of cleavable inorganic matter is contained, it was found that the pad wear deteriorated. On the other hand, in the first to sixteenth examples in which good results were obtained, the contained amount of mica is adjusted to at least 12.0 wt % or at most 24.0 wt %. From these results, it was found that the contained amount of the cleavable inorganic matter is appropriately controlled in order to effectively enhance the efficiency and the wear resistance.

According to the above results, it was confirmed that controlling the inorganic matters having a Mohs hardness of at least 6.5 to less than a predetermined wt % and containing the cleavable inorganic matter within a range of a predetermined wt % are necessary in providing a friction material that satisfies all of rotor wear, DTV growth, occurrence of metal pick-up, efficiency, and pad wear.

### INDUSTRIAL APPLICABILITY

The friction material of the present invention can be applied to a field where a friction material is required, such as a disk brake pad or a brake shoe for a vehicle.

1. (canceled)

2. (canceled)

3. (canceled)

4. (canceled)

5. (canceled)

6. A friction material comprising:
a fiber base material;
a binder;
an organic filler; and
an inorganic filler,
wherein, in the friction material,
a contained amount of copper element is at most 0.5 wt % with respect to a total amount of the friction material,
an inorganic matter having a Mohs hardness of at least 6.5 and a cleavable inorganic matter are contained as the inorganic filler,
the contained amount of the inorganic matter having a Mohs hardness of at least 6.5 is less than 1.0 wt % with respect to the total amount of the friction material, and
the contained amount of the cleavable inorganic matter is at least 12.0 wt % and at most 24.0 wt % with respect to the total amount of the friction material.

7. The friction material according to claim 6, wherein metal fiber or metal alloy fiber is not contained.

8. The friction material according to claim 6, wherein the cleavable inorganic matter is mica.

9. The friction material according to claim 6, wherein an average particle diameter of the inorganic matter having a Mohs hardness of at least 6.5 is at most 25 μm.

10. The friction material according to claim 6, wherein iron oxide is contained as the inorganic filler.

11. The friction material according to claim 10, wherein the contained amount of the iron oxide is at least 5.0 wt % and at most 15.0 wt % with respect to the total amount of the friction material.

12. The friction material according to claim 7, wherein the cleavable inorganic matter is mica.

13. The friction material according to claim 7, wherein an average particle diameter of the inorganic matter having a Mohs hardness of at least 6.5 is at most 25 μm.

14. The friction material according to claim 7, wherein iron oxide is contained as the inorganic filler.

15. The friction material according to claim 14, wherein the contained amount of the iron oxide is at least 5.0 wt % and at most 15.0 wt % with respect to the total amount of the friction material.

16. The friction material according to claim 8, wherein an average particle diameter of the inorganic matter having a Mohs hardness of at least 6.5 is at most 25 μm.

17. The friction material according to claim 8, wherein iron oxide is contained as the inorganic filler.

18. The friction material according to claim 17, wherein the contained amount of the iron oxide is at least 5.0 wt % and at most 15.0 wt % with respect to the total amount of the friction material.

19. The friction material according to claim 12, wherein an average particle diameter of the inorganic matter having a Mohs hardness of at least 6.5 is at most 25 μm.

20. The friction material according to claim 12, wherein iron oxide is contained as the inorganic filler.

21. The friction material according to claim 20, wherein the contained amount of the iron oxide is at least 5.0 wt % and at most 15.0 wt % with respect to the total amount of the friction material.

22. The friction material according to claim 9, wherein iron oxide is contained as the inorganic filler.

23. The friction material according to claim 22, wherein the contained amount of the iron oxide is at least 5.0 wt % and at most 15.0 wt % with respect to the total amount of the friction material.

24. The friction material according to claim 13, wherein iron oxide is contained as the inorganic filler.

25. The friction material according to claim 24, wherein the contained amount of the iron oxide is at least 5.0 wt % and at most 15.0 wt % with respect to the total amount of the friction material.
